(19) United States
(12) Patent Application Publication
(10) Pub. No.: US 2005/0005443 A1
(43) Pub. Date: Jan. 13, 2005

(54) Method for producing a connecting rod for a reciprocating-piston engine

(76) Inventor: Ernst Arnold, Ruhstorf (DE)

Correspondence Address: KATTEN MUCHIN ZAVIS ROSENMAN, 575 MADISON AVENUE, NEW YORK, NY, 10022-2585, US

(21) Appl. No.: 10/829,617

(22) Filed: Apr. 19, 2004

Related U.S. Application Data
(63) Continuation of application No. PCT/EP03/07218, filed on Jul. 5, 2003.

(30) Foreign Application Priority Data
Jul. 16, 2002 (DE) 102 32 265.1

(51) Int. Cl. B23P 17/00; B21D 53/84

(52) U.S. Cl. 29/888.09

(57) ABSTRACT

In a method for producing, from a cast or forged blank, a connecting rod intended for a reciprocating-piston engine and having one little and one big connecting-rod eye, the big connecting-rod eye is split, in a pre-machining step, along a parting plane running through the axis of the eye, the place side faces of the blank being ground beforehand in a first clamping station. After the plane faces of the blank have been ground, first the contour of the big connecting-rod eye and then the split in the parting plane are produced by laser cutting while the blank is held in a second clamping station.

### CROSS-REFERENCE TO RELATED APPLICATIONS

This is a continuation of International Application PCT/EP2003/007218 filed Jul. 5, 2003.

### FIELD OF THE INVENTION

The invention relates to a method for producing, from a cast or forged blank, a connecting rod intended for a reciprocating-piston engine and having one big and one little connecting-rod eye, the big connecting-rod eye being split, in a pre-machining step, along a parting plane running through the axis of the eye, the plane side faces of the blank being ground beforehand in a first clamping station.

### BACKGROUND OF THE INVENTION

In accordance with the generally known procedure for producing connecting rods, the connecting-rod blank is first rough-machined on its plane faces, after which the journal bore is split, for example by sawing, in a further clamping station, and is rough-bored after the two parts have been clamped together (see DE 4306280 A1). In the process, it is expedient to form the journal bore of the blank with oval shape, in such a way as to allow for sawing trim loss and to obtain a circular cross section after the parts have been joined together. After this pre-machining step, which also includes the boring of the piston-pin bore, the two connecting-rod parts are further machined separately in a machining center, specifically by milling of the parting faces, spindling of the fit bores, cutting of the threads for the clamping bolts and milling of the bracing faces for the bolt heads. Only after the two connecting-rod parts have been bolted together is precision machining performed, namely finish-grinding of the plane faces as well as precision boring of the journal eye and of the bushing pressed into the piston-pin bore.

Connecting-rod blanks machined by chip-removing methods in this way require a considerable outlay for machining stations, which have a large space requirement. Because the gripping forces for clamping the workpiece must be large enough to correspond to the cutting pressures, the complexity of the jigs and fixtures has increased with increasing degree of automation. In addition, the expenses for smooth removal of chips in a manner that does not interfere with the automatic machining sequence are not inconsiderable.

Some simplification can be achieved by another known production method, that of manufacturing connecting rods by cracking (see German Patent 19829147 A1). In order to predetermine the fracture plane, two diametrically opposite laser-cut notches are made on the inner circumferential surface of the big connecting-rod eye (see German Patent 19534360 C2). In this method, the need for a complex parting cut for production of the two workpiece parts (connecting-rod shank and connecting-rod cap) is indeed eliminated; on the other hand, increased expenses are needed for jigs and fixtures, since it is necessary on the one hand to transmit particularly high cracking forces and on the other hand to absorb those forces again by suitable clamping jigs and fixtures and to dissipate them into the equipment substructure and foundation.

In contrast, the object of the present invention is to improve the known production methods by reducing the production complexity and simultaneously improving the conditions for automation and environmental compatibility.

### SUMMARY OF THE INVENTION

According to the invention, this object is achieved in conjunction with the method cited in the introduction by the fact that, after the plane faces of the blank have been ground, first the contour of the big connecting-rod eye and then the split in the parting plane are produced by laser cutting while the blank is held in a second clamping station.

Modem techniques permit the use of lasers to achieve high-precision cutting even of relatively thick starting materials for reasonable investments. For example, workpieces with material thicknesses of about 30 mm can be machined with a cutting speed of about 400 mm/min. Control of the cutting sequence is achieved with an accuracy of at least 0.1 mm center deviation for a cut width of about 0.2 mm. Certainly the costs for procurement of such laser cutters are still relatively high; on the other hand, the cutting machines for the parting cut in the parting plane are no longer needed; furthermore, there is no need for boring or milling machines for pre-machining the big connecting-rod eye as well as the piston-pin eye provided at the opposite end of the connecting rod.

Within the scope of the present invention, not only the plane parting cut but also the circular cuts for machining the two connecting-rod eyes are made by the method of laser cutting. In the process, it is expedient for the contour of the big connecting-rod eye to correspond to a cut of circular shape whose diameter is undersized by 0.5 to 1.5 mm compared with the journal diameter, preferably by 0.6 to 1.0 mm. In an alternative version, it can be provided that the contour of the big connecting-rod eye corresponds to a cut of oval shape, wherein the elongation produced is equal to 0.5 to 2 mm, preferably about 1 mm, and is symmetric relative to the parting plane. In this way it is possible without problems to compensate for the width of the cut—which in any case is only about 0.2 mm—made by laser cutting, and a correction for the material loss can be made during subsequent finish machining of the parting faces. Even in the case of a cut of oval shape, the parts of semicircular shape must be made with undersized diameter, as explained hereinabove, to ensure that sufficient trim allowance is available for subsequent finish machining of the big and little connecting-rod eyes by precision boring, which if necessary is preceded by pre-spindling.

Depending on the structure of the blank, the little connecting-rod eye can also be cut out of solid material, so that expenses for cores for forging or casting of the blank can be eliminated. It is self-evident that precision machining of the eye, for example by spindling or reaming, can also be performed expediently after laser cutting of the little connecting-rod eye and before insertion of the bearing bushing. Such precision machining also takes place at the big connecting-rod eye, namely after the connecting-rod shank and connecting-rod cap have been bolted together. This precision machining again has the form of spindling or reaming. This can also be followed by a further machining process such as precision boring. This latter process is also applied to the little connecting-rod eye after insertion of the bearing bushing, which is machined in the same clamping station as the big connecting-rod eye.

Otherwise, after completion of the inventive production method, the workpiece that has been pre-machined by laser cutting is further machined in conventional manner. In other words, the connecting-rod shank and connecting-rod cap are machined separately in a third clamping station in a machining center.

Considered on the whole, significant advantages are achieved by including laser cutting in the process of production of the connecting rod, thus proving the benefits of using this new technology for pre-machining of the blank. Because of the narrow cut width and associated material savings, production of chips is completely avoided. The advantageous consequences of such chip-free operation are not limited to the associated reduction in environmental pollution: because large volumes of chips are avoided, the problems that removal of such chips causes for automation are also avoided. If both the parting cut and production of the two connecting-rod eyes are performed by laser cutting, a distinct reduction of machining time compared with the conventional machining by chip-removing techniques is also achieved. Because of the very small cutting pressures during laser cutting, a special advantage in favor of laser cutting is that the associated gripping forces are extremely small. This circumstance is particularly favorable for construction of the jigs and fixtures that are important for automation. Relatively small clamping jigs and fixtures are needed to hold the workpiece during laser cutting, and so the costs of the clamping jigs and fixtures as well as the associated space requirement can be appreciably reduced. Laser cutting can be employed for both cast and forged blanks. As an example, 42 CrMo4 forgeable steel is suitable.

### BRIEF DESCRIPTION OF THE DRAWINGS

A practical example of the invention will be explained hereinafter on the basis of the drawing, wherein:

FIG. 1 shows a front view of a connecting-rod blank,

FIG. 2 shows a side view corresponding to FIG. 1,

FIG. 3 shows a front view of the connecting-rod shank in partly cutaway form,

FIG. 4 shows a front view of the connecting-rod cap in partly cutaway form,

FIG. 5 shows a front view of the assembled connecting rod, and

FIG. 6 shows a side view corresponding to FIG. 5.

### DETAILED DESCRIPTION OF THE INVENTION

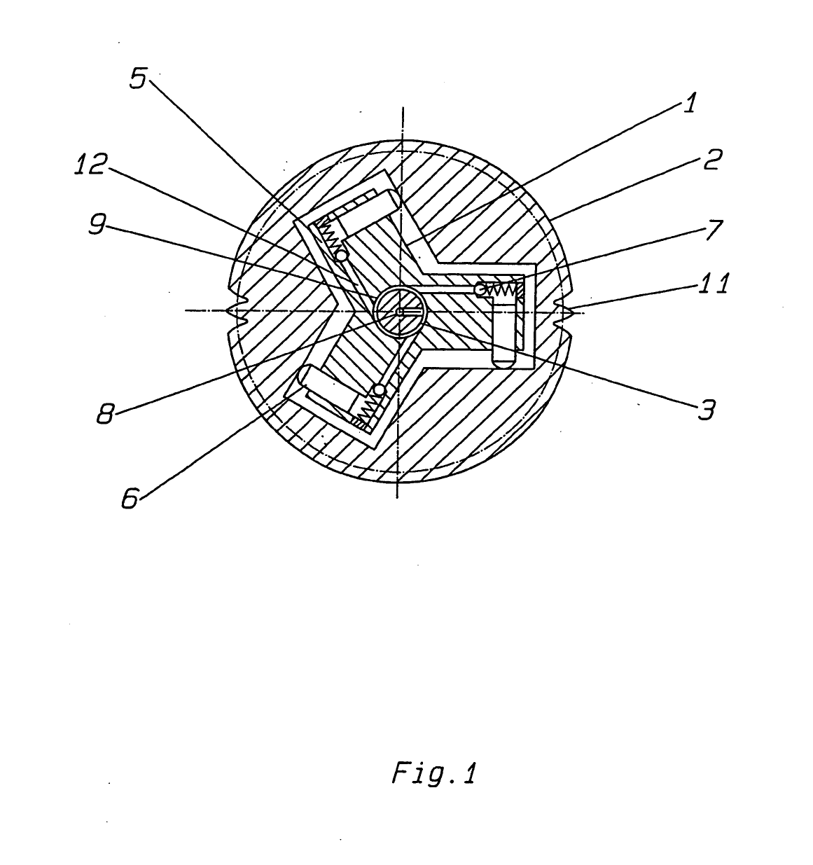

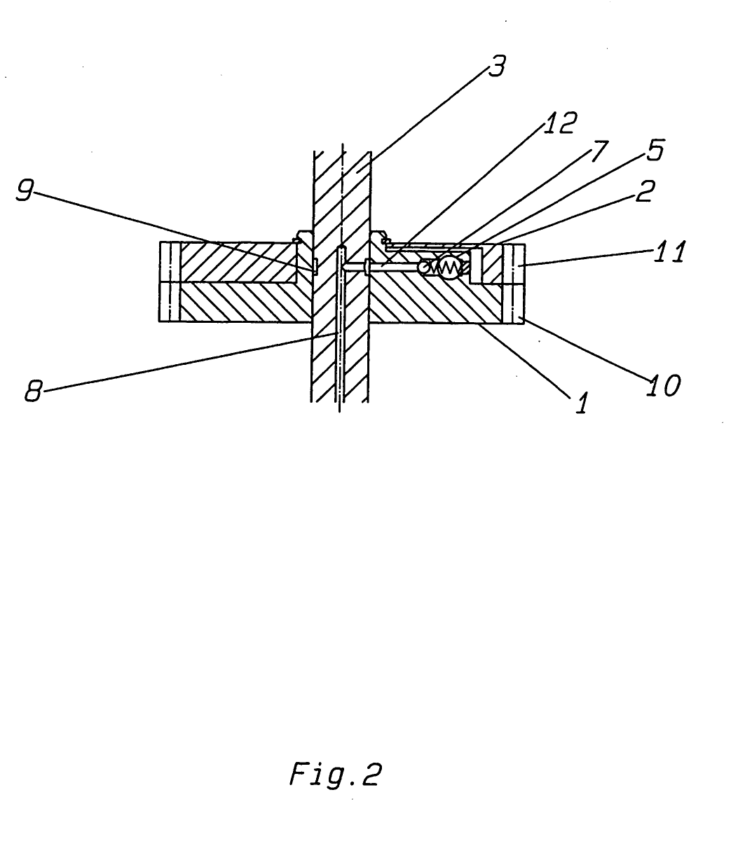

FIGS. 1 and 2 illustrate a connecting-rod blank 1, which can be produced as a cast or forged part. It has two connecting-rod eyes, namely little connecting-rod eye 2 and big connecting-rod eye 3. After appropriate machining, the piston-pin bore is formed from little connecting-rod eye 2, this bore surrounding the piston pin of the piston in the installed condition in a reciprocating-piston engine; from big connecting-rod eye 3 there is obtained the journal bore, which surrounds the crankshaft in the installed condition. In the illustrated practical example there is indicated the cutting plane of the laser cut, by which parting plane 4 between connecting-rod shank 5 and connecting-rod cap 6 is defined. Plane faces 13 form the sides of the connecting-rod eyes.

In the blank shown in FIGS. 1 and 2, big connecting-rod eye 3 has a circular cross section. This means that the planned cut width of the laser cut of approximately 0.2 mm and the post-machining of the parting faces must be compensated for by appropriately undersizing the diameter of the circular laser cut, preferably by an amount of between 0.6 and 1.0 mm. It is only by boring out in the course of subsequent precision machining that a circular bore is once again obtained in the form of the journal bore, in which a bearing shell will be received during subsequent installation.

Instead of making a circular cut during precutting of the big connecting-rod eye by laser cutting, the laser can also be guided in such a way as to make a cut of oval shape, wherein the journal eye is stretched out linearly on both sides of the parting plane. This means that the cross-sectional shape of the big connecting-rod eye is composed of the two opposite semicircular portions and of the linear extension of about 1 mm joining them, with the result that the shape obtained is oval on the whole. In this case, during subsequent precision machining, the parting faces that adjoin parting plane 4 and that were originally formed by laser cutting, are machined, for example by milling, until the precise semicircular dimension is reached. After assembly of the two connecting-rod parts, there is then obtained a circular journal bore, which then needs only to be precision-bored to the correct diameter.

As far as little connecting-rod eye 2 is concerned, it is produced with slightly undersized diameter by an appropriate circular laser cut, and is subsequently precision-machined by spindling or reaming, to ensure that a bearing bushing can be fitted therein. Connecting-rod blank 1 can already be provided with an appropriate bore for little connecting-rod eye 2, as illustrated in FIGS. 1 and 2. Alternatively, however, little connecting-rod eye 2 can also be produced from solid material by laser cutting.

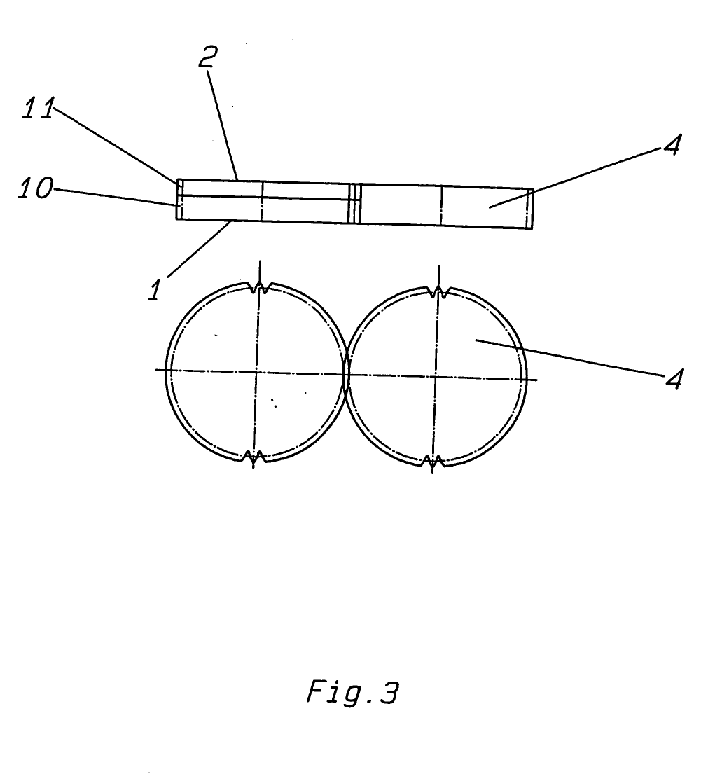

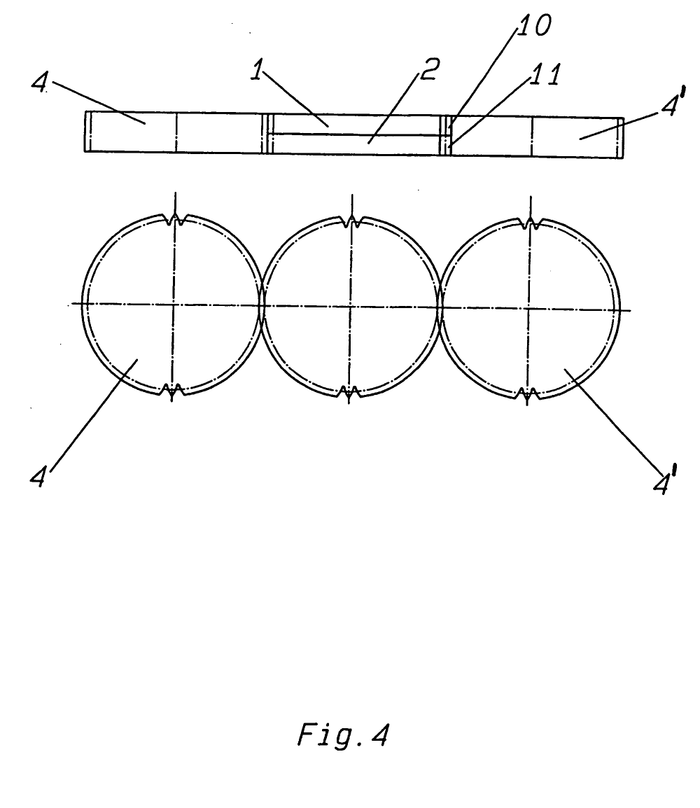

FIG. 3 shows connecting-rod shank 5 after machining of parting faces 7 and boring of fit bore 8 and cutting of thread 9 for the clamping bolts for joining connecting-rod shank 5 to connecting-rod cap 6, as illustrated in FIG. 4.

According to FIG. 4, fit bore 8 of connecting-rod cap 6 is adjoined by a connecting bore 10, which has slightly larger dimension, and against the mouth of which there is braced head 11 of the respective clamping bolt, as illustrated in FIGS. 5 and 6, which show the example of finish-assembled connecting rod 12.

1. A method for producing, from a cast or forged blank having plane side faces, a connecting rod for a reciprocating-piston engine and having one little connecting-rod eye and one big connecting-rod eye, comprising the steps of:
grinding the plane side faces of the cast or forged blank in a first clamping station,
laser cutting the contour of the of the big connecting-rod eye while the cast or forged blank is held in a second clamping station, and
splitting the big connecting-rod eye in a pre-machining step by laser cutting along a parting plane running through an axis of said eye.

2. A method according to claim 1, wherein the contour of the little connecting-rod eye is also produced by laser cutting in the second clamping station.

3. A method according to claim 1, wherein the contour of the big connecting-rod eye corresponds to a cut of circular shape whose diameter is undersized by 0.5 to 1.5 mm compared with a journal diameter formed within the big connecting-rod eye.

4. A method according to claim 3, wherein the amount of the undersize is 0.6 to 1.0 mm.

5. A method according to claim 1, wherein the contour of the big connecting-rod eye corresponds to a cut of oval shape, wherein an elongation produced is equal to 0.5 to 2 mm, and is symmetric relative to the parting plane.

6. A method according to claim 1, wherein a cut width of the laser cutting of about 0.2 mm is adjusted during such cutting.

7. A method according to claim 1, wherein, for pre-machining by laser cutting, the accuracy with which the cut is made is adjusted to about 0.1 mm by a program controller.

8. A method according to claim 1, wherein, after pre-machining by laser cutting, the cast or forged blank is further machined to form a connecting-rod shank and a connecting-rod cap, which are machined separately in a third clamping station in a machining center.

9. A method according to claim 1, wherein the little connecting-rod eye is precision-machined by spindling or reaming.

10. A method according to claim 8, further comprising the steps of bolting the connecting-rod shank and the connecting-rod cap together and precision-machining the large connecting-rod eye by spindling or reaming.
